(19) United States
(12) Patent Application Publication
(10) Pub. No.: US 2014/0183270 A1
(43) Pub. Date: Jul. 3, 2014

(54) ACOUSTIC MAGNETIC TAG

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: TAO SUN, Shenzhen (CN); ZHI-MING LI, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/108,508

(22) Filed: Dec. 17, 2013

(30) Foreign Application Priority Data
Dec. 29, 2012 (CN) 2012105878475

(51) Int. Cl. G06K 19/06

(52) U.S. Cl. CPC G06K 19/06196
USPC 235/493

(57) ABSTRACT

An acoustic magnetic tag includes a casing, a cover, a biasing magnetic piece, a first resonance piece and a second resonance piece. The cover is attached to the casing and covering the casing. The biasing magnetic piece is received in the casing. The first resonance piece and a second resonance piece are received in the casing, wherein a length of the first resonance piece is different from a length of the second resonance piece, resonance frequencies of the first resonance piece and the second resonance piece are the same.

### BACKGROUND

1. Technical Field

The present disclosure relates to a tag, and more particularly, to an acoustic magnetic tag.

2. Description of Related Art

Acoustic magnetic tag may include a biasing magnetic piece and a pair of resonance pieces. The pair of resonance pieces has a same length, and is aroused by the biasing magnetic tag to be in resonance. However, because the pair of resonance pieces has a same length, they will influence each other when in resonance, thereby generating a resonance frequency difference between them. Such that, a yield of the acoustic magnetic tag is reduced.

Therefore, there is room for improvement in the art.

### BRIEF DESCRIPTION OF THE DRAWINGS

The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is an isometric view of an embodiment of an acoustic magnetic tag.

FIG. 2 is a cross-sectional view along line II-II of the acoustic magnetic tag in FIG. 1.

### DETAILED DESCRIPTION

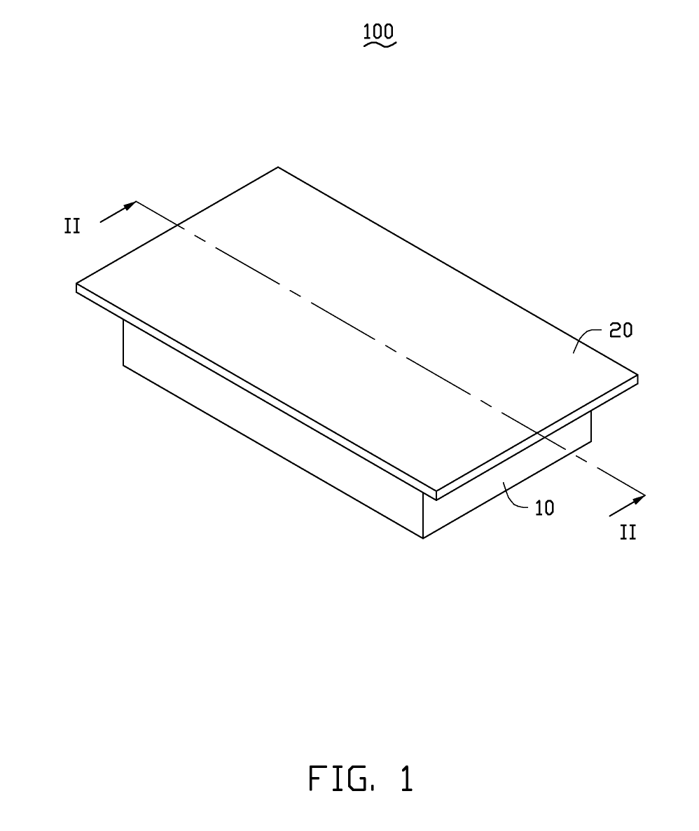

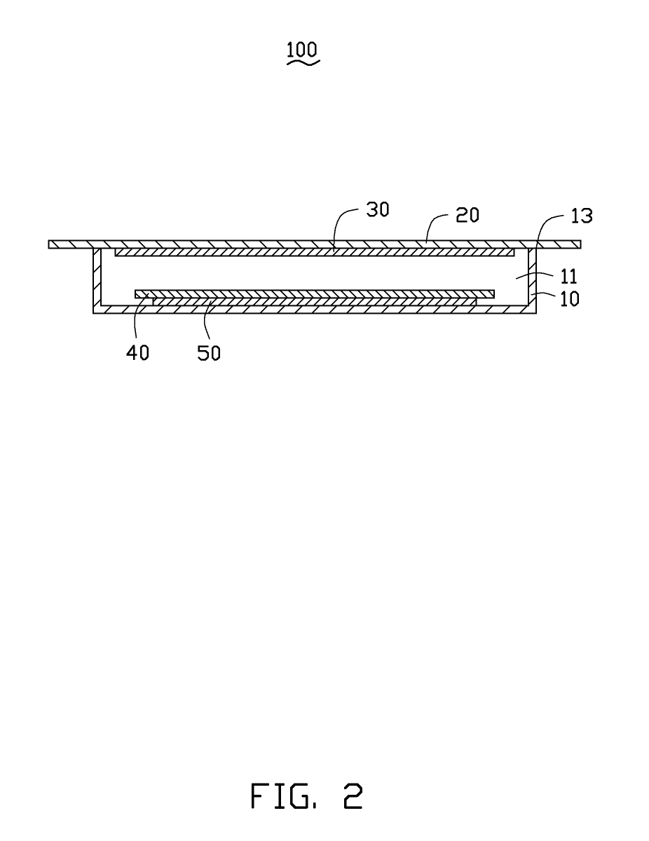

FIGS. 1 and 2 show an embodiment of an acoustic magnetic tag 100. The acoustic magnetic tag 100 includes a casing 10, a cover 20, a biasing magnetic piece 30, a first resonance piece 40, and a second resonance piece 50. The cover 20 is attached to the casing 10 and covers the casing 10. The biasing magnetic piece 30 is attached to an inner surface of the cover 20 facing the casing 10 and is received within the casing 10. The first resonance piece 40 and the second resonance piece 50 are stacked together and received in the casing 10 at a bottom of the casing 10 away from the cover 20. The first resonance piece 40 is located upon the second resonance piece 50 adjacent and aligned to the biasing magnetic piece 30. The first resonance piece 40 and the second resonance piece 50 are aroused by the biasing magnetic piece 30 to resonate at a frequency in a range from about 4.698 KHz to about 54.193 KHz. A thickness of the first resonance piece 40 is equal to that of the second resonance piece 50, and is about 0.03 millimeter.

The casing 10 is substantially rectangular, and defines a receiving chamber 11 in a rectangular shape therein. The casing 10 includes a fixing portion 13 surrounding the receiving chamber 11. In the embodiment, the casing 10 and the cover 20 are made of plastic materials. The cover 20 is attached to the fixing portion 13 and covers the receiving chamber 11. The cover 20 is adhered to the fixing portion 13 by an adhesive coated upon the fixing portion 13. The biasing magnetic piece 30 is substantially in a rectangular shape and made of soft magnetic materials. The biasing magnetic piece 30 is adhered to an inner surface of the cover 20 facing the casing 10 and received in the receiving chamber 11. The first resonance piece 40 and the second resonance piece 50 are substantially rectangular plates, and are made of amorphous alloy, such as Nickel amorphous alloy or Cobalt amorphous alloy. The second resonance piece 50 is attached to the bottom of the receiving chamber 11 of the casing 10, the first resonance piece 40 is stacked on and attached to the second resonance piece 50, and is parallel to the second resonance piece 50 and the biasing magnetic piece 30. The first resonance piece 40 is located below the biasing magnetic piece 30. The first resonance piece 40 and the second resonance piece 50 are aroused by the biasing magnetic piece 30 to resonate. In order to illustrate how the ratio of the length of the first resonance piece 40 to the length of the second resonance piece 50 imposes on the resonance frequency of the first resonance piece 40 and the second resonance piece 50, some examples are listed in tables 1 to 4 below. In all of the examples, the first resonance piece 40 and the second resonance piece 50 are made of Nickel or Cobalt amorphous alloy.

Referring to table 1, in examples 1-34, the ratio of the length of each first resonance piece 40 to the length of the corresponding second resonance piece 50 is about 0.98. The lengths of the first resonance pieces 40 are about 39.74 millimeters to 40.07 millimeters, the lengths of the second resonance pieces 50 are about 40.02 millimeters to 40.72 millimeters. The resonance frequencies of the first resonance pieces 40 and the second resonance pieces 50 are about 53.666 KHz to 54.193 KHz.

TABLE 1
Resonance frequencies of the examples 1 to 34

| | | Length of the | |
|---|---|---|---|
| | Length of the first | second | Resonance |
| | resonance piece | resonance piece | Frequency |
| Ex. | (mm) | (mm) | (KHz) |
| Ex. 1 | 39.74 | 40.02 | 53.896 |
| Ex. 2 | 39.74 | 40.03 | 53.892 |
| Ex. 3 | 39.75 | 40.03 | 54.026 |
| Ex. 4 | 39.97 | 40.32 | 54.003 |
| Ex. 5 | 39.96 | 40.33 | 53.992 |
| Ex. 6 | 39.97 | 40.34 | 53.921 |
| Ex. 7 | 39.96 | 40.34 | 53.912 |
| Ex. 8 | 39.95 | 40.32 | 53.776 |
| Ex. 9 | 39.95 | 40.5 | 53.968 |
| Ex. 10 | 39.96 | 40.5 | 53.975 |
| Ex. 11 | 39.97 | 40.48 | 53.969 |
| Ex. 12 | 39.95 | 40.49 | 54.140 |
| Ex. 13 | 39.93 | 40.5 | 54.056 |
| Ex. 14 | 39.94 | 40.5 | 54.193 |
| Ex. 15 | 39.96 | 40.6 | 53.816 |
| Ex. 16 | 39.95 | 40.61 | 53.893 |
| Ex. 17 | 39.94 | 40.61 | 54.166 |
| Ex. 18 | 39.95 | 40.62 | 54.037 |
| Ex. 19 | 39.96 | 40.61 | 53.796 |
| Ex. 20 | 39.94 | 40.6 | 53.984 |
| Ex. 21 | 39.97 | 40.6 | 53.810 |
| Ex. 22 | 39.95 | 40.6 | 53.666 |
| Ex. 23 | 39.96 | 40.55 | 53.994 |
| Ex. 24 | 39.95 | 40.54 | 54.167 |
| Ex. 25 | 39.94 | 40.56 | 54.128 |
| Ex. 26 | 39.95 | 40.56 | 53.965 |
| Ex. 27 | 39.95 | 40.55 | 54.130 |
| Ex. 28 | 39.96 | 40.54 | 54.014 |
| Ex. 29 | 40.05 | 40.7 | 53.918 |
| Ex. 30 | 40.07 | 40.68 | 53.983 |
| Ex. 31 | 40.07 | 40.72 | 54.018 |
| Ex. 32 | 40.04 | 40.71 | 53.919 |
| Ex. 33 | 40.06 | 40.7 | 53.829 |
| Ex. 34 | 40.05 | 40.71 | 53.745 |

Referring to table 2, in examples 35-43, the ratio of the length of each first resonance piece 40 to the length of the corresponding second resonance piece 50 is about 0.99. The length of the first resonance pieces 40 are about 44.04 millimeters to 45.07 millimeters, the lengths of the second resonance pieces 50 are about 44.52 millimeters to 44.67 millimeters. The resonance frequencies of the first resonance piece 40 and the second resonance piece 50 are about 48.912 KHz to 49.041 KHz.

TABLE 2
Resonance frequencies of the examples 35 to 43

| | | Length of | |
|---|---|---|---|
| | Length of the first | the second | Resonance |
| | resonance | resonance | Frequency |
| Ex. | piece (mm) | piece (mm) | (KHz) |
| Ex. 35 | 44.05 | 44.53 | 48.912 |
| Ex. 36 | 44.06 | 44.53 | 48.879 |
| Ex. 37 | 44.04 | 44.54 | 48.793 |
| Ex. 38 | 44.05 | 44.52 | 48.836 |
| Ex. 39 | 45.06 | 44.66 | 48.869 |
| Ex. 40 | 45.07 | 44.64 | 48.935 |
| Ex. 41 | 45.06 | 44.67 | 48.636 |
| Ex. 42 | 45.06 | 44.65 | 49.041 |
| Ex. 43 | 45.05 | 44.66 | 49.011 |

Referring to table 3, in examples 44-51, the ratio of the length of each first resonance piece 40 to the length of the corresponding second resonance piece 50 is about 0.99. The lengths of the first resonance pieces 40 are about 52.32 millimeters to 53.08 millimeters, the lengths of the second resonance pieces 50 are about 52.82 millimeters to 53.35 millimeters. The resonance frequencies of the first resonance piece 40 and the second resonance piece 50 are about 41.244 KHz to 41.519 KHz.

TABLE 3
Resonance frequencies of the examples 44 to 51

| | | Length of | |
|---|---|---|---|
| | Length of the first | the second | Resonance |
| | resonance | resonance | Frequency |
| Ex. | piece (mm) | piece (mm) | (KHz) |
| Ex. 44 | 52.33 | 52.83 | 41.326 |
| Ex. 45 | 52.33 | 52.84 | 41.244 |
| Ex. 46 | 52.32 | 52.82 | 41.364 |
| Ex. 47 | 53.07 | 53.35 | 41.36 |
| Ex. 48 | 53.08 | 53.34 | 41.333 |
| Ex. 49 | 53.07 | 53.34 | 41.325 |
| Ex. 50 | 53.08 | 53.33 | 41.519 |
| Ex. 51 | 53.07 | 53.33 | 41.356 |

Referring to table 4, in examples 52-64, the ratio of the length of each first resonance piece 40 to the length of the corresponding second resonance piece 50 is about 0.99. The lengths of the first resonance pieces 40 are about 62.2 millimeters to 63.13 millimeters, the lengths of the second resonance pieces 50 are about 62.39 millimeters to 62.66 millimeters. The resonance frequencies of the first resonance piece 40 and the second resonance piece 50 are about 34.698 KHz to 34.914 KHz.

TABLE 4
Resonance frequencies of the examples 52 to 64

| | | Length of | |
|---|---|---|---|
| | Length of the first | the second | Resonance |
| | resonance | resonance | Frequency |
| Ex. | piece (mm) | piece (mm) | (KHz) |
| Ex. 52 | 62.23 | 62.4 | 34.863 |
| Ex. 53 | 62.2 | 62.39 | 34.821 |
| Ex. 54 | 62.21 | 62.42 | 34.797 |
| Ex. 55 | 62.2 | 62.41 | 34.796 |
| Ex. 56 | 62.21 | 62.4 | 34.698 |
| Ex. 57 | 62.23 | 62.39 | 34.87 |
| Ex. 58 | 62.22 | 62.42 | 34.748 |
| Ex. 59 | 62.23 | 62.42 | 34.903 |
| Ex. 60 | 62.22 | 62.42 | 34.914 |
| Ex. 61 | 63.12 | 62.64 | 34.795 |
| Ex. 62 | 63.12 | 62.65 | 34.905 |
| Ex. 63 | 63.13 | 62.65 | 34.863 |
| Ex. 64 | 63.13 | 62.66 | 34.823 |

In other embodiments, the biasing magnetic piece 30 can be attached to the bottom of the receiving chamber 11, the first resonance piece 40 and the second resonance piece 50 are attached to the cover 20 and aligned to the biasing magnetic piece 30. The first resonance piece 40 is located between the second resonance piece 50 and the bottom of the receiving chamber 11.

The resonance frequency of the first resonance piece 40 and the second resonance piece 50 can be adjusted by changing the ratio of the length of the first resonance piece 40 to the length of the second resonance piece 50, such that the range of resonance frequencies of the first resonance piece 40 and the second resonance piece 50 are concentrated, and a feedback signal of the acoustic magnetic tag 100 is more intense. Thus, a yield of the acoustic magnetic tag 100 is increased.

The ratio of lengths of the first resonance piece 40 and the second resonance 50 is not limited to 0.98 to 0.99 as above-mentioned. Lengths of the first resonance piece 40 and the second resonance piece 50 may be changed according to materials of the first resonance piece 40 and the second resonance piece 50, and a ratio of lengths of the first resonance piece 40 and the second resonance piece 50 is changed, thereby obtaining a range of resonance frequencies.

Finally, while various embodiments have been described and illustrated, the disclosure is not to be construed as being limited thereto. Various modifications can be made to the embodiments by those skilled in the art without departing from the true spirit and scope of the disclosure as defined by the appended claims.

What is claimed is:

1. An acoustic magnetic tag, comprising:
a casing;
a cover attached to the casing and covering the casing;
a biasing magnetic piece received in the casing;
a first resonance piece received in the casing; and
a second resonance piece received in the casing, wherein a length of the first resonance piece is different from a length of the second resonance piece, resonance frequencies of the first resonance piece and the second resonance piece are substantially the same.

2. The acoustic magnetic tag of claim 1, wherein thicknesses of the first resonance piece and the second resonance piece are substantially the same.

3. The acoustic magnetic tag of claim 1, wherein the biasing magnetic piece is attached to the cover, the first and the second resonance pieces are stacked together.

4. The acoustic magnetic tag of claim 1, wherein the first resonance piece and the second resonance piece are made of Nickel amorphous alloy or Cobalt amorphous alloy.

5. The acoustic magnetic tag of claim 4, wherein the ratio of the length of the first resonance piece to the length of the second resonance piece is about 0.98, the resonance frequency of the first resonance piece and the second resonance piece is in a range of from about 53.666 to about 54.193 KHz.

6. The acoustic magnetic tag of claim 5, wherein the length of the first resonance piece is about 39.74 to 40.07 millimeters, the length of the second resonance piece is about 40.02 to 40.72 millimeters.

7. The acoustic magnetic tag of claim 4, wherein the ratio of the length of the first resonance piece to the length of the second resonance piece is about 0.99.

8. The acoustic magnetic tag of claim 7, wherein the length of the first resonance piece is about 44.04 to 45.07 millimeters, the length of the second resonance piece is about 44.52 to 44.67 millimeters, the resonance frequency of the first resonance piece and the second resonance piece is in a range of from about 48.912 to about 49.041 KHz.

9. The acoustic magnetic tag of claim 7, wherein the length of the first resonance piece is about 52.32 to 53.08 millimeters, the length of the second resonance piece is about 52.82 to 53.35 millimeters, the resonance frequency of the first resonance piece and the second resonance piece is in a range of from about 41.244 to about 41.519 KHz.

10. An acoustic magnetic tag, comprising:
a casing defining a receiving chamber and comprising a fixing portion surrounding the receiving chamber;
a cover attached to the fixing portion and covering the receiving chamber of the casing;
a biasing magnetic piece attached to the cover;
a first resonance piece received in the receiving chamber and
a second resonance piece received in the receiving chamber, wherein a length of the first resonance piece is different from a length of the second resonance piece, resonance frequencies of the first resonance piece and the second resonance piece are substantially the same.

11. The acoustic magnetic tag of claim 10, wherein thicknesses of the first resonance piece and the second resonance piece are substantially the same.

12. The acoustic magnetic tag of claim 10, wherein the biasing magnetic piece is attached to an inner surface of the cover facing the casing, the second resonance piece is attached to the bottom of the receiving chamber of the casing, the first resonance piece is attached to the second resonance piece, and parallel to the second resonance piece and the biasing magnetic piece.

13. The acoustic magnetic tag of claim 11, wherein the first resonance piece and the second resonance piece are made of alloy of Nickel amorphous alloy and Cobalt amorphous alloy.

14. The acoustic magnetic tag of claim 13, wherein the ratio of the length of the first resonance piece to the length of the second length resonance piece is about 0.98, the resonance frequency of the first resonance piece and the second resonance piece is in a range of from about 53.666 to about 54.193 KHz.

15. The acoustic magnetic tag of claim 14, wherein the length of the first resonance piece is about 39.74 to 40.07 millimeters, the length of the second resonance piece is about 40.02 to 40.72 millimeters.

16. The acoustic magnetic tag of claim 13, wherein the ratio of the length of the first resonance piece to the length of second resonance piece is about 0.99.

17. The acoustic magnetic tag of claim 16, wherein the length of the first resonance piece is about 44.04 to 45.07 millimeters, the length of the second resonance piece is about 44.52 to 44.67 millimeters, the resonance frequency of the first resonance piece and the second resonance piece is in a range from about 48.912 to about 49.041 KHz.

18. The acoustic magnetic tag of claim 16, wherein the length of the first resonance piece is about 52.32 to 53.08 millimeters, the length of the second resonance piece is about 52.82 to 53.35 millimeters, the resonance frequency of the first resonance piece and the second resonance piece is in a range of from about 41.244 to about 41.519 KHz.
